(19) United States
(12) Patent Application Publication
(10) Pub. No.: US 2026/0061829 A1
(43) Pub. Date: Mar. 5, 2026

(54) Independently Controllable Driving Wheel

(71) Applicant: Xia HAN, Jilin (CN)

(72) Inventor: Xia HAN, Jilin (CN)

(21) Appl. No.: 18/817,679

(22) Filed: Aug. 28, 2024

(51) Int. Cl. B60K 7/00; B60K 17/04

(52) U.S. Cl. CPC B60K 7/0007; B60K 17/043

(57) ABSTRACT

Disclosed is an independently controllable driving wheel, which comprises a hub and a driving assembly, wherein the driving assembly comprises a mounting seat which can be mounted on an axle, and an output member, a gear set and a driving member which are mounted on the mounting seat; the mounting seat is rotatably connected with the hub and the output member respectively; the output member has a driving end and an output end; the driving member drives the driving end to rotate through the gear set; the output end is engaged with the hub to drive the driving wheel to rotate. According to the present invention, a gearbox and multi-stage speed change gears in the gearbox are arranged, so that the movement of a stroller can be kept stable in a case that the driving motor adopts a high power.

### TECHNICAL FIELD

The present invention relates to the technical field of hub motors, in particular to an independently controllable driving wheel.

### BACKGROUND

In the prior art, the stroller wheel of a stroller adopts the structure in which the rear wheel and the motor are separated, that is, the drive is realized through the motor acceleration and deceleration gear box. This defect lies in that the installation position of the drive system should be considered when designing the wheel structure, and the externally mounted drive system will occupy limited space of the car body. Such products are complex, bulky and too heavy, which also has a certain impact on aesthetics.

In order to solve the above problems, U.S. Pat. No. 11,569,704 proposed an “In-wheel motor”, which can improve the structural rigidity of the wheel rim itself, improve the waterproof performance of the wheel motor, and improve the convenience of tire replacement operation.

However, the hub motor in the above technical solution greatly increases the volume of the hub because of its structure. At the same time, because the motor needs to be integrated and installed inside the hub, the driving motor will generate a lot of noise when driving the gear transmission mechanism to work, which will affect the use effect of the stroller.

Therefore, there is a need to propose an independently controllable driving wheel, which has a gear box and multi-stage speed change gears in the gear box, so that the stroller movement can be kept stable under the condition that the driving motor adopts high power, and the provided one-body wheel can be directly applied to the existing baby carriage body structure and axle. At the same time, because the driving motor is longitudinally assembled in the limiting groove, the noise generated by the driving motor when the driving gear transmission mechanism works is reduced.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim

The present invention provides an independently controllable driving wheel, which includes a hub and a driving assembly, wherein the driving assembly includes a mounting seat which can be mounted on an axle, and an output member, a gear set and a driving member which are mounted on the mounting seat; the mounting seat is rotatably connected with the hub and the output member respectively, and the output member has a driving end and an output end; the driving member drives the driving end to rotate through the gear set, and the output end is engaged with the hub to drive the driving wheel to rotate.

The present invention further provides an independently controllable driving wheel, which includes a hub and a mounting seat which can be connected to an axle, wherein the hub is rotatably connected with the mounting seat, and an output gear, a gear set and a driving member are mounted on the mounting seat; the output gear is rotatably arranged on the mounting seat, and the output gear is provided with a gear part meshed with the gear set and an engaging shaft engaged with the hub; and the driving member rotates the output gear through the gear set to further drive the driving wheel to rotate.

The present invention further provides an independently controllable driving wheel, which includes a hub and a mounting seat, wherein the hub is rotatably connected with the mounting seat, and the mounting seat is provided with a polygonal hole into which an axle can be inserted; the mounting seat is provided with an output gear, a gear set and a driving motor; the mounting seat is formed with a positioning groove along a width direction of the driving wheel, and the driving motor is mounted in the positioning groove along the width direction of the driving wheel; the output gear is rotatably arranged on the mounting seat, and the output gear is provided with a gear part meshed with the gear set and an engaging shaft engaged with the hub, and the driving motor rotates the output gear through the gear set to further drive the driving wheel to rotate.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of the overall structure of a preferred embodiment of the present invention;

FIG. 2 is an explosion schematic diagram of the preferred embodiment of the present invention;

FIG. 3 is a schematic structural view of the mounting seat of the preferred embodiment of the present invention with the right movable shell removed;

FIG. 4 is an explosion schematic diagram of the gear set according to the preferred embodiment of the present invention;

FIG. 5 is a schematic diagram of the overall structure of the hub according to the preferred embodiment of the present invention;

FIG. 6 is a partially enlarged structural diagram of FIG. 5;

FIG. 7 is a schematic structural view of the right movable shell according to the preferred embodiment of the present invention;

FIG. 8 is another schematic view of the right movable shell structure of the preferred embodiment of the present invention;

FIG. 9 is a schematic structural view of the left movable shell according to the preferred embodiment of the present invention;

FIG. 10 is another schematic diagram of the right movable shell structure of the preferred embodiment of the present invention;

FIG. 11 is a schematic diagram of the overall structure of the mounting seat according to the preferred embodiment of the present invention;

FIG. 12 is a sectional view of the overall structure of the preferred embodiment of the present invention.

### REFERENCE SIGNS

Hub (1000); Mounting seat (2000); Tire (3000); Power cord (4000); Engaging part (1100); Engaging ring (1110); Engaging post (1120); First groove (1121); Second groove (1122); Third groove (1123); Cavity (1200); Fixed cover (1300); Left movable shell (2110); Positioning groove (2111); Right movable shell (2120); Fixed cylinder (2121-1); Connecting groove (2123); Fixed post (2121-2); Pillow block (2124); Power cord hole (2125); Bearing (2126); Output gear (2200); Engaging shaft (2210); First bump (2211); Second bump (2212); Gear part (2220); First gear (2310); First bull gear (2311); First pinion (2312); Second gear (2320); Second bull gear (2321); Second pinion (2322); Third gear (2330); Third gear (2331); Third pinion (2332); Driving member (2400); Driving motor (2410); Motor gear (2420); First fixed shaft (2500); Second fixed shaft (2501); Third fixed shaft (2502).

### Description of Embodiments

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

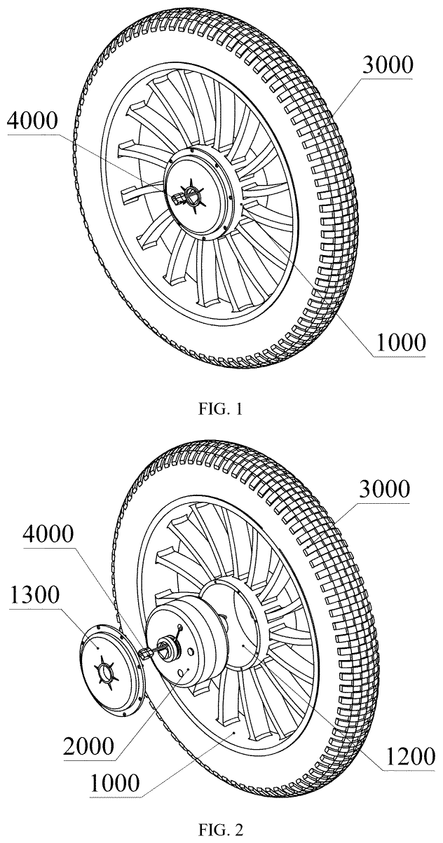

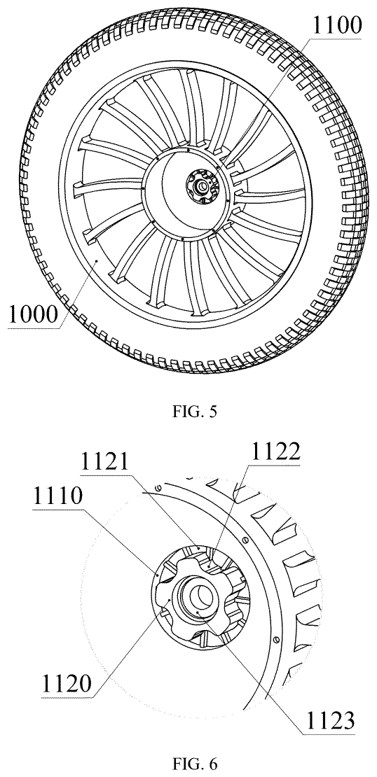

As a preferred embodiment of the present invention, as shown in FIGS. 1-12, the present invention provides an independently controllable driving wheel, which includes a hub 1000 and a driving assembly. The driving assembly includes a mounting seat 2000 which can be mounted on an axle, and an output member, a gear set and a driving member 2400 which are mounted on the mounting seat 2000. The mounting seat 2000 is rotatably connected with the hub 1000 and the output member respectively. The output member has a driving end and an output end. The driving member 2400 drives the driving end to rotate through the gear set, and the output end is engaged with the hub 1000 to drive the driving wheel to rotate.

A tire 3000 is arranged around the hub 1000. A cavity 1200 is arranged in the hub 1000, and the driving assembly is installed in the cavity 1200. The hub 1000 is fixedly provided with a fixed cover 1300 covering the opening of the cavity 1200, and the fixed cover 1300 is rotatably arranged on the fixing cylinder 2121-1. One side of the fixed cover 1300 near the fixed cylinder 2121-1 is provided with a bearing groove opposite to the bearing 2126. The fixed cover 1300 and the hub 1000 are connected by screws to ensure the stability and reliability of the wheel after the whole assembly.

One side of the cavity 1200 of the hub 1000 near the mounting seat 2000 is provided with an engaging part 1100, and the engaging part 1100 is arranged in the middle of the hub 1000. When the fixed cover 1300 is fixedly connected with the hub 1000, the bearing groove of the fixed cover 1300 engages with the bearing 2126 of the fixing cylinder 2121-1, and the mounting seat 2000 remains stationary relative to the axle. The output end of the mounting seat 2000 is engaged and matched with the engaging part 1100 of the hub 1000 to drive the driving wheel to rotate.

The engaging part 1100 includes an engaging ring 1110 and an engaging post 1120, wherein a certain distance is left between the engaging post 1120 and the engaging ring 1110 to form a first groove 1121. The engaging post 1120 is formed with a plurality of equidistantly arranged second grooves 1122 in the circumferential direction, and the second grooves 1122 are approximately semicircular. The center of the engaging post 1120 is provided with a circular third groove 1123. A circular first bump 2211 corresponding to the third groove 1123 is formed in the middle of the engaging shaft 2210, and a plurality of second bumps 2212 corresponding to the second grooves 1122 are formed in the engaging shaft 2210 in the circumferential direction. When the engaging shaft 2210 is inserted into the first groove 1121, the first bump 2211 is engaged in the third groove 1123, and the second bumps 2212 are engaged in the second grooves.

In some embodiments (not shown), the fixed cover 1300 and the hub 1000 can be connected by screws, and the fixed cover 1300 and the hub 1000 can also be connected by magnetism. The fixed cover 1300 and the hub 1000 are respectively installed with magnetic members, and the two parts are attracted together by magnetism. The magnetic connection is mostly suitable for occasions requiring frequent disassembly and installation. Alternatively, screw thread is arranged between them to connect the fixed cover 1300 and the hub 1000 in a screw way. The screw thread connection not only has a certain connection strength, but also facilitates disassembly and maintenance of the internal drive assembly.

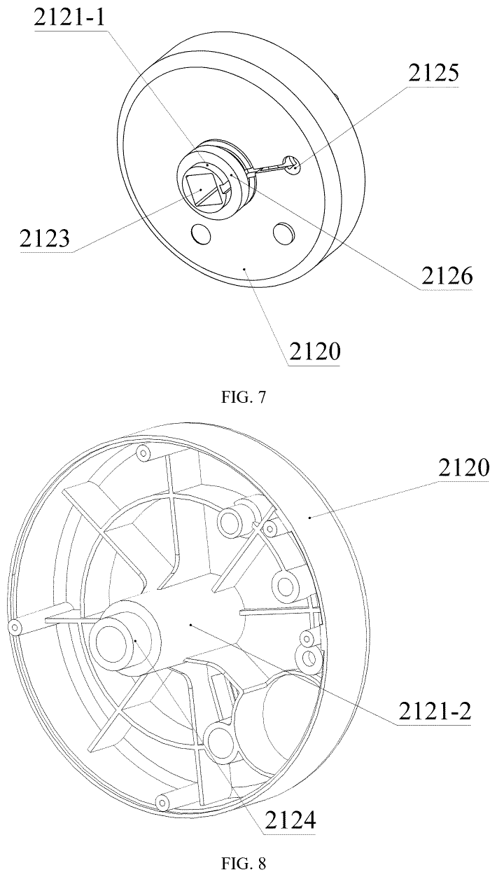

As shown in FIGS. 7-8, the output member includes an output gear 2200 rotatably arranged on the left movable shell 2110, and the output gear 2200 includes an engaging shaft 2210 and a gear part 2220. The engaging shaft 2210 is arranged as an output end and the gear part 2220 is a driving end. The driving end is meshed with the gear set, the gear set is driven by the driving member 2400 to drive the driving end to rotate, and then the output end is driven to drive the hub 1000 to drive the driving wheel to rotate.

A fixed post 2121-2 adapted to the engaging shaft 2210 is arranged in the right movable shell 2120, and a fixed hole is arranged in the fixed post 2121-2. A pillow block 2124 is arranged on the fixed post 2121-2, and the engaging shaft 2210 of the output member is movably sleeved on the pillow block 2124. A through hole is arranged in the middle of the left movable shell 2110, the size of the through hole is the same as that of the engaging shaft 2210, and the engaging shaft 2210 can rotate in the left movable shell 2110.

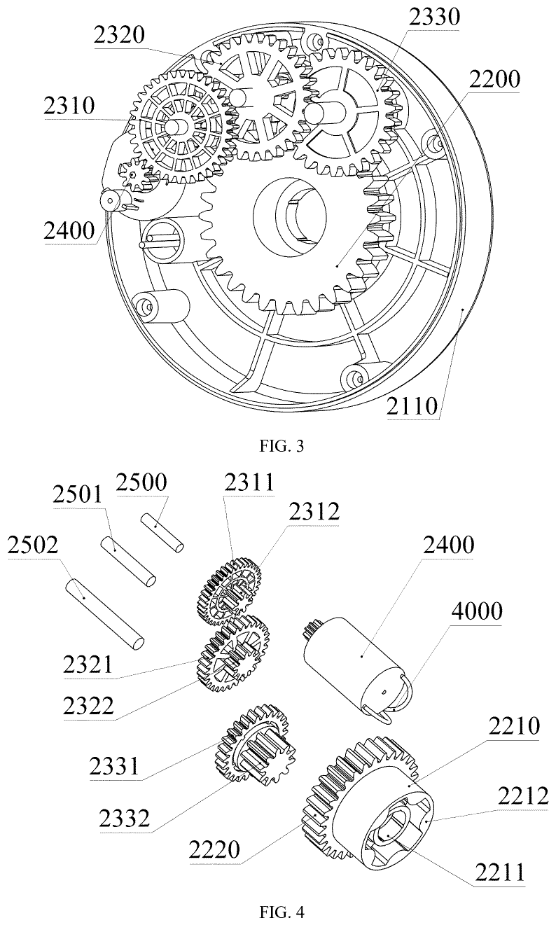

As shown in FIG. 3-FIG. 4, the gear set includes a first gear 2310, a second gear 2320 and a third gear 2330 which are in meshing transmission in sequence. The left movable shell 2110 is provided with a first fixed shaft 2500, a second fixed shaft 2501 and a third fixed shaft 2502, and the right movable shell 2120 is provided with grooves opposite to thereto. When the left and right movable shells are assembled, the first fixed shaft 2500, the second fixed shaft 2501 and the third fixed shaft 2502 are fixed in the grooves of the right movable shell. The first gear 2310 is rotatably arranged on the first fixed shaft 2500, the second gear 2320 is rotatably arranged on the second fixed shaft 2501, and the third gear 2330 is rotatably arranged on the third fixed shaft 2502. The first gear 2310 is in meshing transmission with the driving member 2400, and the third gear 2330 is in meshing transmission with the gear part 2220.

In this embodiment, the first gear 2310, the second gear 2320 and the third gear 2330 of the gear set all adopt a gear-and-spur gear duplex meshing mechanism. By a gear part 2220 with gears are mutually meshed in the internal output member, the driving member 2400 drives the gear set to run the output member so as to output the power to the hub 1000 to drive the wheel to run. In the above structure, the first gear 2310, the second gear 2320 and the third gear 2330 are all small-sized gears, and the overall structure of the gear set is smaller. At the same time, the combined application of the driving motor 2410 can reduce the output current, thereby reducing the power consumption and prolonging the service life of the wheel.

The first gear 2310 includes a first bull gear 2311 and a first pinion 2312, the second gear 2320 includes a second bull gear 2321 and a second pinion 2322, and the third gear 2330 includes a third bull gear 2331 and a third pinion 2332. The first bull gear 2311 is in mesh transmission with the driving member 2400, the first pinion 2312 is in mesh transmission with the second bull gear 2321, the second pinion 2322 is in mesh transmission with the third bull gear 2331, and the third pinion 2332 is in mesh transmission the gear part 2220.

As shown in FIG. 7, a fixed cylinder 2121-1 is provided outside the right movable shell 2120. The center of the end of the fixed cylinder 2121-1 is provided with a polygonal connecting groove 2123, which can be connected to the axle to realize the detachable connection with the vehicle body. The polygonal connecting groove 2123 is mainly used to fix the position of the mounting seat 2000 in the hub 1000. When the driving assembly drives the wheel to rotate, because the mounting seat 2000 is fixed on the axle through the polygonal connecting groove 2123, the mounting seat 2000 will not rotate with the wheel, thus ensuring the stability and reliability of the driving wheel.

The shape of the connecting groove 2123 is preferably square. Compared with other polygonal connecting grooves 2123, the square connecting groove 2123 is not only simple in structure and convenient to install, but also can save costs and improve benefits in the production process. The square design makes the connecting groove 2123 more efficient in the manufacturing and assembly process, and also enhances the stability and firmness of the connection, ensuring the safety and durability of the wheel during use.

In addition, the right movable shell 2120 is further provided with a power cord hole 2125, and the driving member 2400 is provided with a power cord 4000. The power cord 4000 passes out of the right movable shell 2120 through the power cord hole 2125, and is connected to the power supply to provide necessary power support for the driving member 2400. This design not only simplifies the wiring process of the power line, but also improves the safety and reliability of the whole drive system.

In this embodiment, a bearing 2126 is arranged on the periphery of the end of the fixed cylinder 2121-1, which is closely matched with the fixed cylinder 2121-1. The existence of the bearing 2126 can avoid the direct contact between the fixed cylinder 2121-1 and the fixed cover 1300, reduce the friction generated by the wheel during use, improve the structural strength and overall firmness of the hub 1000, and also reduce the shaking of the vehicle during riding, so that the tire 3000 can bear certain shearing force and impact force during driving. In some embodiments (not shown), the fixed cylinder 2121-1 is provided with a groove matched with the inner ring of the bearing 2126. The groove is filled with glue, and the bearing 2126 is closely connected with the fixed cylinder 2121-1 through glue to prevent the bearing 2126 from falling off during the running of the wheel.

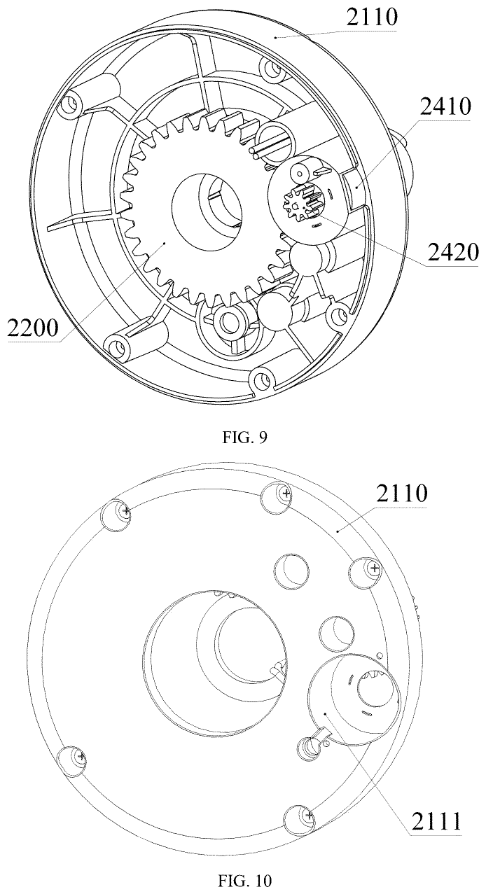

As shown in FIGS. 9 and 10, the left movable shell 2110 is formed with a positioning groove 2111 along the width direction of the driving wheel. The driving member 2400 includes a driving motor 2410 and a motor gear 2420 arranged in the positioning groove 2111. When the driving wheel is vertical to the ground, the driving motor 2410 is installed in the positioning groove 2111 along the width direction of the driving wheel, and the rotating shaft of the driving motor 2410 passes through the left movable shell 2110 through the positioning groove 2111 to be in transmission connection with the motor gear 2420 and meshed with the gear set.

In this embodiment, the gear set is skillfully installed in the mounting seat 2000. Because the driving member 2400 is installed in the positioning groove 2111 longitudinally, this installation mode makes the driving member 2400 have stable gear transmission, accurate transmission ratio, high transmission efficiency and large transmission torque when working at high power, and improves the service performance of the whole stroller. After the wheel is assembled as a whole, it presents an integrated appearance, which is not only beautiful, but also very practical and convenient, and low in cost.

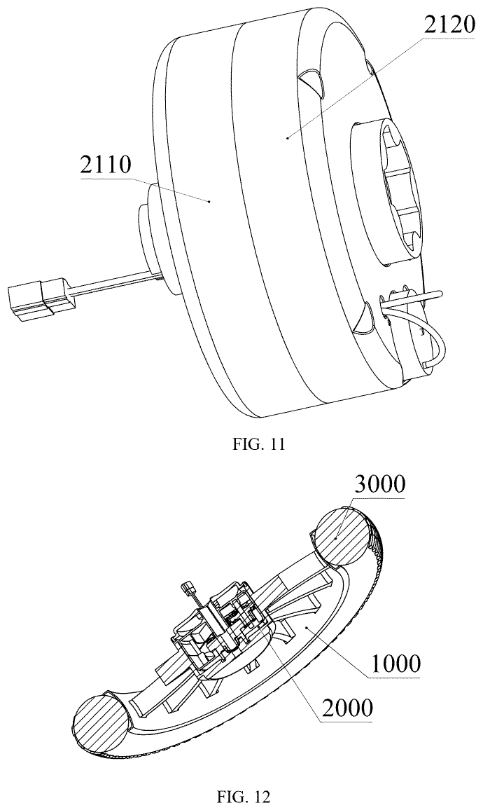

As shown in FIG. 11, the mounting seat 2000 is generally cylindrical. The mounting seat 2000 includes a left movable shell 2110 and a right movable shell 2120, which are detachably connected. The right movable shell 2120 is provided with a plurality of screw holes, and the left movable shell 2110 is fastened to the right movable shell 2120 with bolts through the screw holes.

In some embodiments (not shown), the connection mode of the left movable shell 2110 and the right movable shell 2120 is not limited to bolt connection. For example, magnets are installed on the left movable shell 2110 and the right movable shell 2120, and the two parts are attracted together by magnetic force. This method is suitable for occasions requiring frequent disassembly and installation. The left movable shell 2110 and the right movable shell 2120 can also be provided with fasteners and slots, and the left movable shell 2110 and the right movable shell 2120 can be fixed together through the fasteners and slots, which is suitable for occasions requiring accurate positioning and fixing. Alternatively, a bolt is provided to fix the two parts together, which is suitable for rapid assembly and disassembly and has high stability. This diversified design makes the mounting seat 2000 have more flexible application scenarios, and at the same time, it is convenient for later maintenance or replacement of parts inside the mounting seat 2000, and the service life of the drive assembly is prolonged. Whether in industrial application or daily use, this design shows its superior practicability and reliability.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. An independently controllable driving wheel, comprising a hub (1000) and a driving assembly, wherein the driving assembly comprises a mounting seat (2000) which can be mounted on an axle, and an output member, a gear set and a driving member (2400) which are mounted on the mounting seat (2000); the mounting seat (2000) is rotatably connected with the hub (1000) and the output member respectively, and the output member has a driving end and an output end; the driving member (2400) drives the driving end to rotate through the gear set, and the output end is engaged with the hub (1000) to drive the driving wheel to rotate.

2. The independently controllable driving wheel according to claim 1, wherein the mounting seat (2000) comprises a left movable shell (2110) and a right movable shell (2120); the output member is rotatably arranged on the left movable shell (2110), and the output end passes through the left movable shell (2110) to be engaged with the hub (1000).

3. The independently controllable driving wheel according to claim 2, wherein the output member comprises an output gear (2200) rotatably arranged on the left movable shell (2110); the output end is an engaging shaft (2210) arranged on the output gear (2200), and the driving end is a gear part (2220) arranged on the output gear (2200); the engaging shaft (2210) is rotatably connected with the left movable shell (2110) and an end thereof extends to the outside of the left movable shell (2110) to be engaged with the hub (1000).

4. The independently controllable driving wheel according to claim 3, wherein the right movable shell (2120) is provided with a fixed cylinder (2121-1), and an end of the fixed cylinder (2121-1) is provided with a connecting groove (2123) which can be connected with an axle; the hub (1000) is provided with a cavity (1200), and the driving assembly is installed in the cavity (1200); the hub (1000) is fixedly provided with a fixed cover (1300) covering an opening of the cavity (1200); and the fixed cover (1300) is rotatably arranged on the fixed cylinder (2121-1).

5. The independently controllable driving wheel according to claim 4, wherein the connecting groove (2123) is a polygonal through hole.

6. The independently controllable driving wheel according to claim 4, wherein a fixed post (2121-2) coaxial with the fixed cylinder (2121-1) is arranged in the right movable shell (2120), a pillow block (2124) is arranged on the fixed post (2121-2) to drive the output gear (2200), and the driving end of the output gear (2200) is movably sleeved on the pillow block (2124).

7. The independently controllable driving wheel according to claim 4, wherein an engaging part (1100) is arranged in the cavity (1200) of the hub, and the engaging part (1100) is arranged in the middle of the hub (1000); the engaging shaft (2210) and the engaging part (1100) are engaged and matched with each other to drive the driving wheel to rotate.

8. The independently controllable driving wheel according to claim 7, wherein the engaging part (1100) comprises an engaging ring (1110) and an engaging post (1120); a first groove (1121) is arranged between the engaging post (1120) and the engaging ring (1110); the engaging post (1120) is formed with a plurality of second grooves (1122) which are equidistantly arranged along a circumferential direction, and the center of the engaging post (1120) is provided with a third groove (1123).

9. The independently controllable driving wheel according to claim 8, wherein a first bump (2211) corresponding to the third groove (1123) is formed in the middle of the engaging shaft (2210), and a plurality of second bumps (2212) corresponding to the second grooves (1122) are formed in the engaging shaft (2210) along a circumferential direction; when the engaging shaft (2210) is inserted into the first groove (1121), the first bump (2211) is engaged in the third groove (1123), and the second bump (2212) is engaged in the second groove (1122).

10. The independently controllable driving wheel according to claim 3, wherein the gear set comprises a first gear (2310), a second gear (2320) and a third gear (2330) which are in meshing transmission in sequence; the left movable shell (2110) is provided with a first fixed shaft (2500), a second fixed shaft (2501) and a third fixed shaft (2502); the first gear (2310) is rotatably arranged on the first fixed shaft (2500), the second gear (2320) is rotatably arranged on the second fixed shaft (2501), and the third gear (2330) is rotatably arranged on the third fixed shaft (2502); and the first gear (2310) is in meshing transmission with the driving member (2400) and the third gear (2330) is in meshing transmission with with the gear part (2220).

11. The independently controllable driving wheel according to claim 10, wherein the first gear (2310) comprises a first bull gear (2311) and a first pinion (2312), the second gear (2320) comprises a second bull gear (2321) and a second pinion (2322), and the third gear (2330) comprises a third bull gear (2331) and a third pinion (2332); the first bull gear (2311) is in meshing transmission with the driving member (2400), the first pinion (2312) is in meshing transmission with the second bull gear (2321), the second pinion (2322) is in meshing transmission with the third bull gear (2331), and the third pinion (2332) is in meshing transmission with the gear part (2220).

12. The independently controllable driving wheel according to claim 2, wherein the left movable shell (2110) is formed with a positioning groove (2111) along a width direction of the driving wheel, and the driving member (2400) comprises a driving motor (2410) arranged on the positioning groove (2111); the driving motor (2410) is installed in the positioning groove (2111) along a width direction of the driving wheel, and a rotating shaft of the driving motor (2410) passes through the positioning groove (2111) and is in meshed with the gear set.

13. The independently controllable driving wheel according to claim 12, wherein the right movable shell (2120) is provided with a power cord hole (2125), the driving member (2400) is provided with a power cord (4000), and the power cord (4000) passes out of the right movable shell (2120) through the power cord hole (2125) to be connected to the power supply.

14. An independently controllable driving wheel, comprising a hub (1000) and a mounting seat (2000) which can be connected to an axle, wherein the hub (1000) is rotatably connected with the mounting seat (2000), and an output gear (2200), a gear set and a driving member (2400) are mounted on the mounting seat (2000); the output gear (2200) is rotatably arranged on the mounting seat (2000), and the output gear (2200) is provided with a gear part (2220) meshed with the gear set and an engaging shaft (2210) engaged with the hub (1000); and the driving member (2400) rotates the output gear (2200) through the gear set to further drive the driving wheel to rotate.

15. The independently controllable driving wheel according to claim 14, wherein the mounting seat (2000) is formed with a positioning groove (2111) along a width direction of the driving wheel, and the driving member (2400) comprises a driving motor (2410) arranged on the positioning groove (2111); the driving motor (2410) is installed in the positioning groove along the width direction of the driving wheel, and a rotating shaft of the driving motor (2410) passes through the mounting seat (2000) via the positioning groove (2111) and is engaged with the gear set.

16. The independently controllable driving wheel according to claim 15, wherein an engaging part (1100) is arranged in the cavity (1200) of the hub, and the engaging part (1100) is arranged in the middle of the hub (1000); and the engaging shaft (2210) and the engaging part (1100) are engaged and matched with each other to drive the driving wheel to rotate.

17. The independently controllable driving wheel according to claim 14, wherein one side of the hub (1000) is provided with a cavity (1200) with an opening, the mounting seat (2000) is installed in the cavity (1200), and a fixed cover (1300) covering the opening of the cavity (1200) is fixedly arranged on the hub (1000); the mounting seat (2000) is formed with a fixed cylinder (2121-1) coaxial with the engaging shaft (2210), and the fixed cylinder (2121-1) extends in an opposite direction of the engaging shaft (2210); and an end of the fixed cylinder (2121-1) is provided with a connecting groove (2123) which can be connected to the axle, and the fixed cover (1300) is rotatably arranged on the fixed cylinder (2121-1).

18. The independently controllable driving wheel according to claim 14, wherein the gear set comprises a first gear (2310), a second gear (2320) and a third gear (2330) which are in meshing transmission in sequence; a left movable shell (2110) is provided with a first fixed shaft (2500), a second fixed shaft (2501) and a third fixed shaft; the first gear (2310) is rotatably arranged on the first fixed shaft (2500), the second gear (2320) is rotatably arranged on the second fixed shaft (2501), the third gear (2330) is rotatably arranged on the third fixed shaft (2502); and the first gear (2310) is in mesh transmission with the driving member (2400) and the third gear (2330) is in mesh transmission with the gear part (2220).

19. The independently controllable driving wheel according to claim 18, wherein the first gear (2310) comprises a first bull gear (2311) and a first pinion (2312), the second gear (2320) comprises a second bull gear (2321) and a second pinion (2322), and the third gear comprises a third bull gear (2331) and a third pinion (2332); the first bull gear (2311) is in meshing transmission with the driving member (2400), the first pinion (2312) is in meshing transmission with the second bull gear (2321), the second pinion (2322) is in meshing transmission with the third bull gear (2331), and the third pinion (2332) is in meshing transmission with the gear part (2220).

20. An independently controllable driving wheel, comprising a hub (1000) and a mounting seat (2000), wherein the hub (1000) is rotatably connected with the mounting seat (2000), and the mounting seat (2000) is provided with a polygonal hole into which an axle can be inserted; the mounting seat (2000) is provided with an output gear (2200), a gear set and a driving motor (2410); the mounting seat (2000) is formed with a positioning groove (2111) along a width direction of the driving wheel, and the driving motor (2410) is mounted in the positioning groove (2111) along the width direction of the driving wheel; the output gear (2200) is rotatably arranged on the mounting seat (2000), and the output gear (2200) is provided with a gear part (2220) meshed with the gear set and an engaging shaft (2210) engaged with the hub (1000), and the driving motor (2410) rotates the output gear (2200) through the gear set to further drive the driving wheel to rotate.
